(19) United States
(12) Patent Application Publication
(10) Pub. No.: US 2023/0281626 A1
(43) Pub. Date: Sep. 7, 2023

(54) SYSTEM, DEVICE AND METHOD FOR GOLD TRANSACTION

(71) Applicant: Lien Hao Chuang, Kaohsiung (TW)

(72) Inventor: Lien Hao Chuang, Kaohsiung (TW)

(21) Appl. No.: 17/901,567

(22) Filed: Sep. 1, 2022

(30) Foreign Application Priority Data
Mar. 7, 2022 (TW) 111108254

(51) Int. Cl. G06Q 20/40; G06Q 20/42; G06Q 20/38; G06Q 40/02; G06Q 20/20

(52) U.S. Cl. CPC G06Q 20/4014; G06Q 20/208; G06Q 20/38215; G06Q 20/42; G06Q 40/025; G06Q 2220/00

(57) ABSTRACT

A system, a device and a method for gold transaction, wherein, after logging into the membership account, the user can buy, sell, or pledge pre-register a gold card with identification information on the system or owned gold, gold jewellery, etc. through the interaction with the machine to obtain the corresponding payment in real time. Since each transaction and the gold sold by the machine will be recorded in the membership account. Accordingly, the system, the device and the method for gold transaction of the present disclosure can ensure the fairness of the transaction and the authenticity of the gold without the need for a third party agency.

### BACKGROUND OF INVENTION

### Field of the Present Disclosure

The present disclosure relates to a system, a device and a method for gold transaction, in particular to a gold transaction system, device and method for recording gold transaction by the radio frequency identification technology to ensure the fairness of gold transactions and the authenticity of gold.

### Brief Description of Related Art

With the development of technology and Internet, various traditional trading behaviors have also changed from actual face-to-face transactions to transactions through the Internet. Even gold with high value preservation is no exception. When trading gold online today, due to the lack of professional third-party units to check in the middle, buyers and sellers often have a low sense of trust, making the probability of gold trading online very low. In today’s online gold trading, due to the lack of professional third-party units to check the buyers and sellers, the trust of buyers and sellers is often very low, thereby making the probability of online gold transactions very low. Therefore, the current way of gold trading still relies on an impartial third-party agency. Once the transaction is successful, both buyers and sellers usually need to pay an agency fee. Accordingly, how to allow buyers and sellers to trade gold online or offline without the need for a third-party agency to ensure the fairness of the transaction and the authenticity of the gold is still a problem to be resolved.

### SUMMARY OF INVENTION

It is a primary object of the present disclosure to provide a system, a device and a method for gold transaction that allow buyers and sellers to conduct online or offline gold transactions in a fair transaction way. Meanwhile, the authenticity of gold can be ensured without the need for a third-party agency.

According to the present disclosure, a control circuit is provided in a machine. When a user interface module in the control circuit receives a membership information transmitted by an information device held by a user, a membership module determines whether the user has a membership account according to the membership information. If the user has a membership account, a wireless communication element on a container containing pre-sold gold or pre-pledged loan gold is read by a reading device to obtain an identification information. Meanwhile, a checking device is configured to sense the gold not accommodated in the container to obtain a sensing information. Moreover, a computing module is configured to calculate a gold purchase price or a pledge-loan gold price according to the identification information or the sensing information and a real-time gold price. The aforementioned price is transmitted to the information device, allowing the user to choose to sell or pledge the gold. Furthermore, a cash flow module is configured to transfer an amount corresponding to the above-mentioned price into the membership account based on the confirmation information. In this way, after logging into the membership account, the user can buy, sell, or pledge pre-register a gold card with identification information on the system or owned gold, gold jewellery, etc. through the interaction with the machine to obtain the corresponding payment in real time.

When the confirmation information is the confirmation of the pledged loan, a certificate module will convert the confirmation information into a certificate, and record the certificate in the membership account and the wireless communication element on the gold container. If the aforesaid gold is not accommodated in the container, it is packaged in a container with another wireless communication element. Thereafter, the certificate is recorded on the wireless communication element on the packaging container. In this way, the authenticity of the gold for pledged loan can be ensured, thereby stabilizing consumers’ trust in gold transactions.

### BRIEF DESCRIPTION OF THE DRAWINGS

FIG. 1 is a block diagram of the structure of a system according to the present disclosure;

FIG. 2 is a block diagram of the structure of a device according to the present disclosure;

FIG. 3 is a flow chart of a method according to the present disclosure;

FIG. 4 is an implementation view I of the present disclosure;

FIG. 5 is an implementation view II of the present disclosure;

FIG. 6 is an implementation view III of the present disclosure;

FIG. 7 is an implementation view IV of the present disclosure;

FIG. 8 is an implementation view V of the present disclosure;

FIG. 9 is an implementation view VI of the present disclosure; and

FIG. 10 is an implementation view VII of the present disclosure.

### DETAILED DESCRIPTION OF PREFERRED EMBODIMENTS

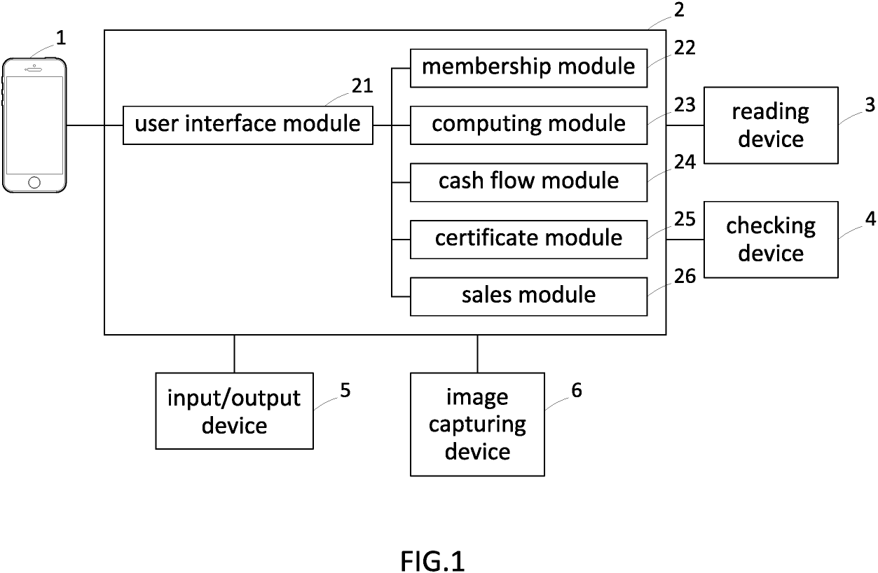

Referring to FIG. 1, the gold transaction system includes an information device 1, a data processing device 2, a reading device 3, a checking device 4, an input/output device 5, and an image capturing device 6. All of the above-mentioned devices are in information connection to each other. The data processing device 2 includes a user interface module 21, a membership module 22, a computing module 23, and a cash flow module 24. The aforementioned modules are in information connection to each other. The user interface module 21 is an Application (APP) or a web page in a web browser for the user to connect to the system of the present disclosure through the information device 1 as well as to receive the information generated by the user’s operation on the information device 1. The membership module 22 is configured to determine whether the user is a member and for recording the relevant information of the member. The computing module 23 is configured to calculate a gold pre-sale price or a pre-pledged loan gold price according to the real-time price of gold. The cash flow module 24 is configured to processes cash flow payment related matters. The reading device 3 is configured to read the information recorded in the one-dimensional barcode, the two-dimensional barcode, a wireless communication element, etc. The checking device 4 is configured to measure one or a combination of the weight, purity, and specific gravity of gold. The input/output device 5 is configured to collect, sell, package, pre-sold, or pre-pledge gold. The image capturing device 6 is configured to capture the images of the verification process, the gold transaction process, and the images of the users who operate the system.

In one embodiment, the user interface module 21 receives a membership information transmitted by the information device 1 while the membership module 22 determines whether the user has a membership account according to the membership information. If the user has the membership account, the reading device 3 reads an identification information stored in a wireless communication element on a container containing pre-sold or pre-pledge loan gold. The computing module 23 calculates a price of the gold, such as the purchase price or/and the pledge loan price according to the identification information and the real-time price of gold, and transmits the aforementioned price to the information device 1 through the user interface module 21 to obtain a confirmation information. If the sale or/and the pledge loan are confirmed, the cash flow module 24 then transfers the corresponding price to the membership account based on the confirmation information. The identification information is one or a combination of the weight and purity of gold pre-recorded in the wireless communication element.

In one embodiment, when the pre-sold or pre-pledged gold is not accommodated in the container, the checking device 4 senses the gold to obtain a sensing information. The computing module 23 calculates the price of gold according to the sensing information and the real-time price of gold. When the cash flow module 24 remits the corresponding price to the membership account, the input/output device 5 packages the pre-sold or pre-pledged gold in a container with another wireless communication element. The sensing information is one of weight value in air, weight value in water, secondary X-ray or a combination thereof.

As shown in FIG. 1, the data processing device 2 further includes a certificate module 25 that is in information connection with other modules. When the confirmation information is the confirmation of the pledged loan gold, the certificate module 25 will convert the confirmation information and/or the sensing information into a certificate which is recorded in the membership account. The reading device 3 records the certificate in the wireless communication element on the container for accommodating gold.

As shown in FIG. 1, the data processing device 2 further includes a sales module 26 that is in information connection with other modules. When the user does not have the membership account, the sales module 26 drives the input/output device 5 to provide another gold stored in another container based on a selection information received by the user interface module 21 and a payment information received by the cash flow module 24. Preferably, the container is a card having the wireless communication element. In another embodiment, when the user has the membership account and intends to purchase gold as an investment or gift first, the certificate module 25 converts a pre-order information and a payment information received by the user interface module 21 into a certificate. The certificate is recorded in the user’s membership account or another user’s membership account. Moreover, the sales module 26 drives the input/output device 5 to provide the gold contained in the container based on the aforementioned certificate.

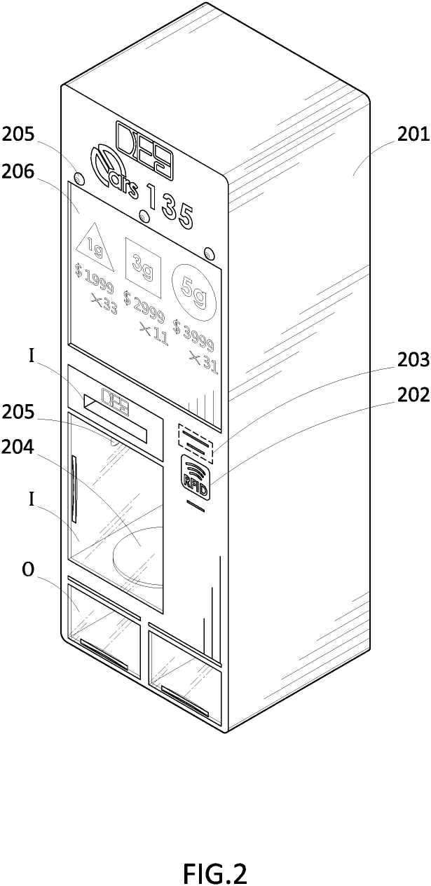

As shown in FIG. 2, the gold transaction device includes a machine 201. A transceiver, a reader 202, a control circuit, a payment unit 203, an inspecting and sensing unit 204, and at least one video camera 205, a display 206, and an input/output unit are disposed inside the machine 201. The aforementioned devices/units are informationally or electrically connected to each other. The outside of the machine 201 includes at least one product inlet I and at least one product outlet O. The transceiver is a media attachment unit (MAU), which is configured to connect other information devices through the network and receive real-time gold prices from an external database. The reader 202 is one or a combination of a one-dimensional barcode scanner, a two-dimensional barcode scanner, a Near-field communication (NFC) reader, a Radio Frequency Identification (RFID) reader, or a chip card reader, for reading the information recorded in one-dimensional barcodes, two-dimensional barcodes, wireless communication components, etc. The control circuit has a processor and a memory. The processor can access a specific command code from the memory and execute the application program defined by the specific command code. The payment unit 203 is one or a combination of a coin-operated mechanism with a coin slot, an electronic sensing module with a sensing area, or other third-party payment institutions. The inspecting and sensing unit 204 is one or a combination of a weight sensor in air, a weight sensor in water, or an X-ray fluorescence spectrometer. The input/output unit is a robotic arm or other device that can move gold for collecting, selling, packaging the pre-sold or pre-pledged gold.

In one embodiment, the control circuit is configured to determine whether the user has the membership account based on membership information received by the transceiver from an information device held by the user. If the user has the membership account, the control circuit calculates the gold price based on the identification information received by the reader 202 from the wireless communication element on the container containing the pre-sold or pre-pledged gold and the real-time price of gold received by the transceiver. The aforementioned price can be transmitted to the information device 1 through the transceiver to obtain the confirmation information, such as confirming the sale or/and confirming the pledge loan. Then, the corresponding price is remitted to the membership account based on the confirmation information. In another embodiment, the control circuit converts the confirmation information into the certificate and records it in the member’s account. The reader 202 can also record the certificate in the wireless communication element on the container for accommodating the gold.

In one embodiment, when the pre-sold or pre-pledged gold is not contained in the container and is placed in the product inlet I, the inspecting and sensing unit 204 inspects and senses the gold to obtain the sensing information. The control circuit calculates the price of gold according to the sensing information and the real-time price of gold. When the control circuit remits the money of the corresponding price into the membership account, the input/output unit is driven to package the pre-sold or pre-pledged gold in a container with another wireless communication element; in another embodiment, the control circuit. In another embodiment, the control circuit converts the confirmation information into the certificate and records it in the member’s account. The reader 202 can also record the certificate in the wireless communication element on the container for packaging the gold.

In one embodiment, the control circuit drives the input/output unit to output another gold contained in another container to a product outlet O based on the product selection information received by the transceiver and the payment information received by the payment unit 203. Preferably, the container is a card having the wireless communication element. In another embodiment, the control circuit converts the pre-order information and the payment information received by the transceiver into a certificate, and records the certificate in the user’s membership account or another user’s membership account. When the control circuit receives the certificate, the input/output unit is driven to output the designated gold contained in another container to the product outlet O.

In one embodiment, the video camera 205 is configured to capture at least one image of the process of inspecting the pre-sold or pre-pledged gold and at least one image of the user operating the device. The images are stored in the membership account to ensure that the fairness and the authenticity of the transaction process.

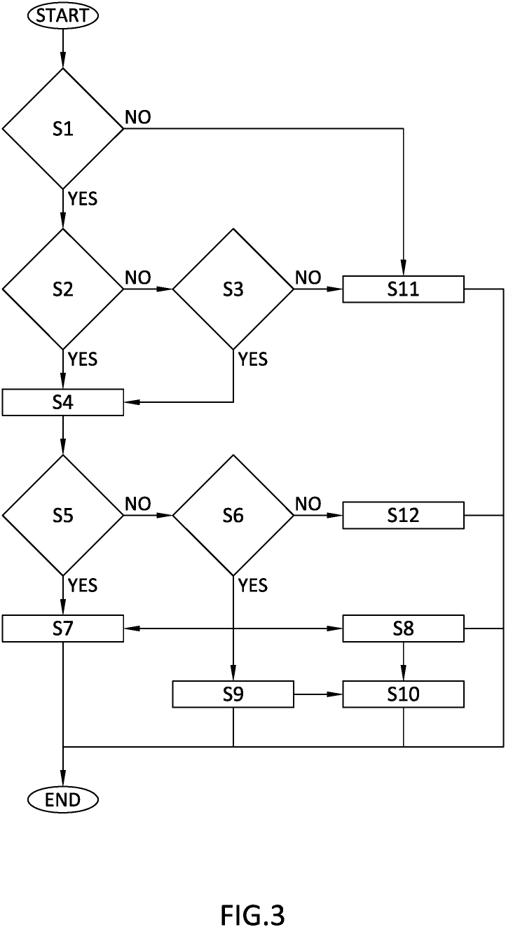

As shown in FIG. 1 and FIG. 3, a method for gold transaction according to the present disclosure includes the following steps:

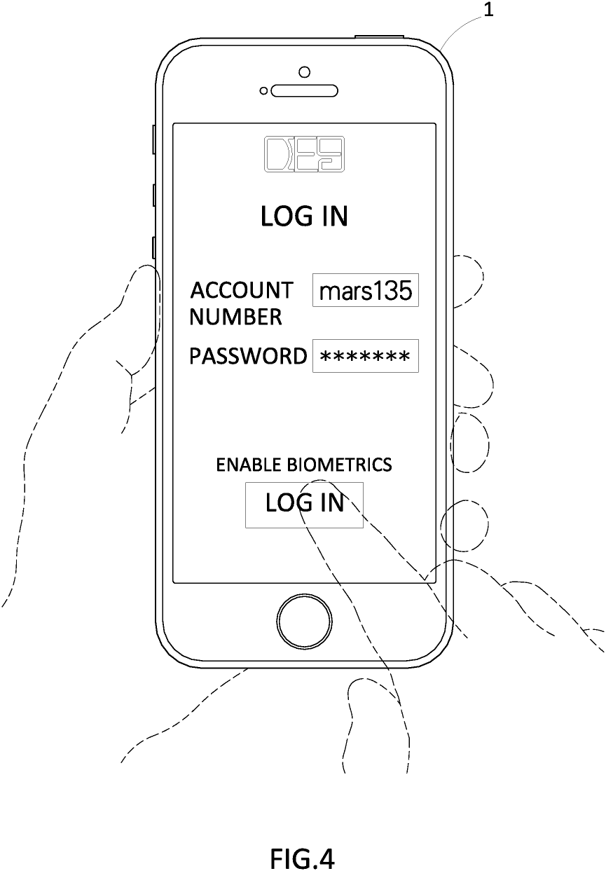

Step S1 of checking whether a user is a member (see FIG. 4), wherein the user interface module 21 receives the membership information transmitted by the information device 1 held by the user while the membership module 22 determines whether the user has the membership account according to the membership information. If the user has the membership account, the step S2 of reading the identification information is executed; if the user does not have the membership account, the step S11 of purchasing a gold card is executed.

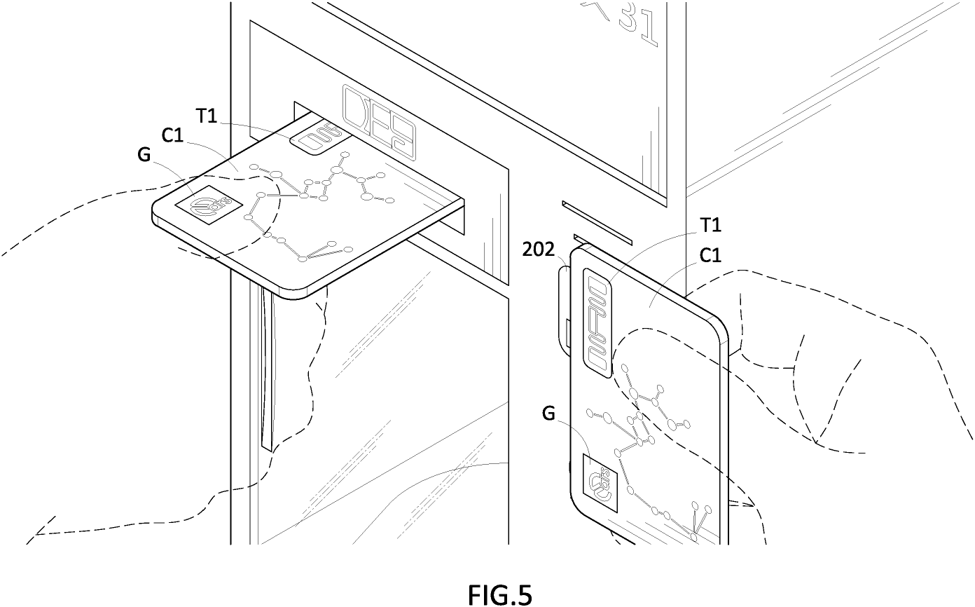

Step S2 of checking whether an identification information is read (see FIG. 5), the reading device 3 (corresponding to the reader 202) is configured to determine whether the identification information stored in the wireless communication element T1 on the container C1 containing the pre-sold or pre-pledged gold G is received or not. If yes, the step S4 of calculating gold price is executed; if no, execute the step S3 whether gold is sensed. The identification information is one or a combination of gold weight and purity pre-recorded in the wireless communication element T1.

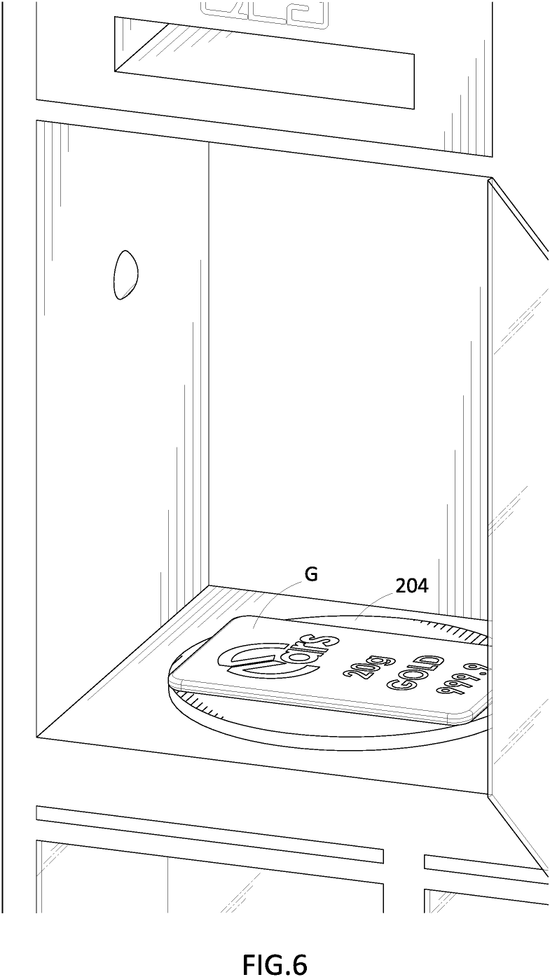

Step S3 of checking whether gold is sensed (see FIG. 6). When the pre-sold or pre-pledged gold G is not accommodated in the container, the checking device 4 (corresponding to the inspecting and sensing unit 204) is configured to check the gold and determine whether the gold is sensed to create a sensing information. If yes, the step S4 of calculating gold price is executed; if no, the step S11 of purchasing gold card. The sensing information is one or a combination of weight value in air, weight value in water, or secondary X-ray.

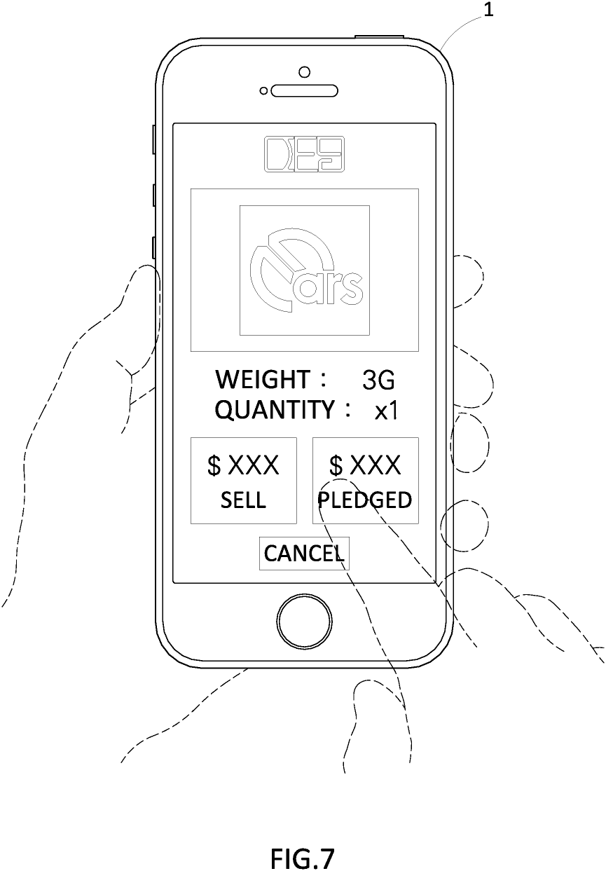

Step S4 of calculating the gold price (see FIG. 7). A purchase price of the pre-sold or a pledge price of the pre-pledged gold G is calculated by the computing module 23 according to the identification information or the sensing information and the real-time price of gold. The aforementioned price is transmitted to the information device 1 through the user interface module 21 to obtain a confirmation information.

Step S5 of checking whether the sale is carried out. The computing module 23 determines whether the confirmation information is the confirmation of sales. If yes, the step S7 of executing remittance is executed; if no, the step S6 of checking whether the pledge process is carried out is executed.

Step S6 of checking whether a pledge loan is carried out. The computing module 23 determines whether the confirmation information is confirmation for the pledge loan. If yes, the step S7 of executing remittance, the step S8 of generating certificate, and the step S9 of packaging gold are simultaneously executed; if no, the step S12 of returning is executed.

Step S7 of executing remittance: The cash flow module 24 transfers an amount corresponding to the purchase price or the pledge loan price to the membership account based on the confirmation information.

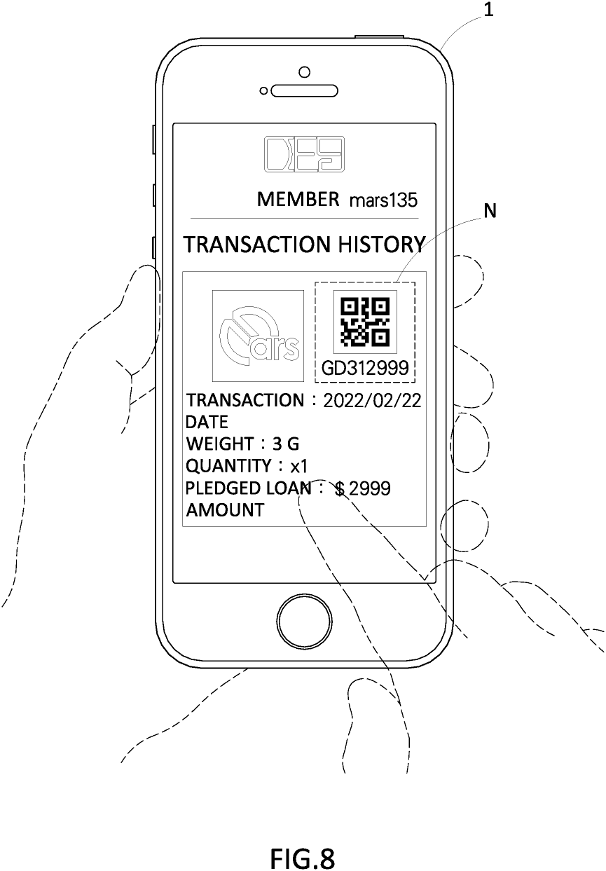

Step S8 of generating certificate (see FIG. 8): The certificate module 25 converts the confirmation information into a certificate N. Meanwhile, the certificate N is recorded in the membership account. In another embodiment, a further step S10 of recording in the container is executed.

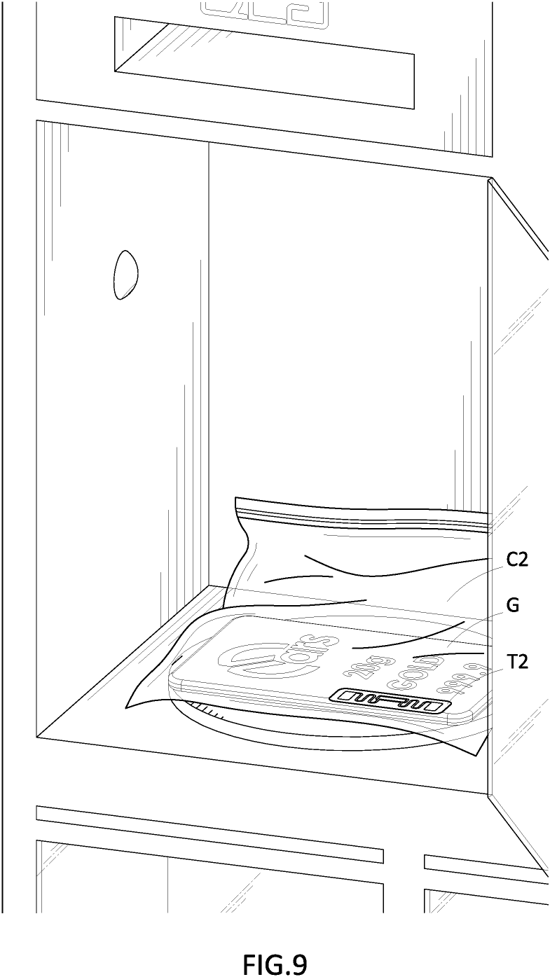

Step S9 of packaging gold (see FIG. 9): If the price of the pre-sold or pledged gold G is calculated through the sensing information, the gold G is packaged into a container C2 with another wireless communication element T2 through the input/output device 5. Meanwhile, the step S10 of recording in the container is executed.

Step S10 of recording in the container: The certificate is recorded in the wireless communication elements T1, T2 on the containers C1, C2 containing the gold G by the reading device 3.

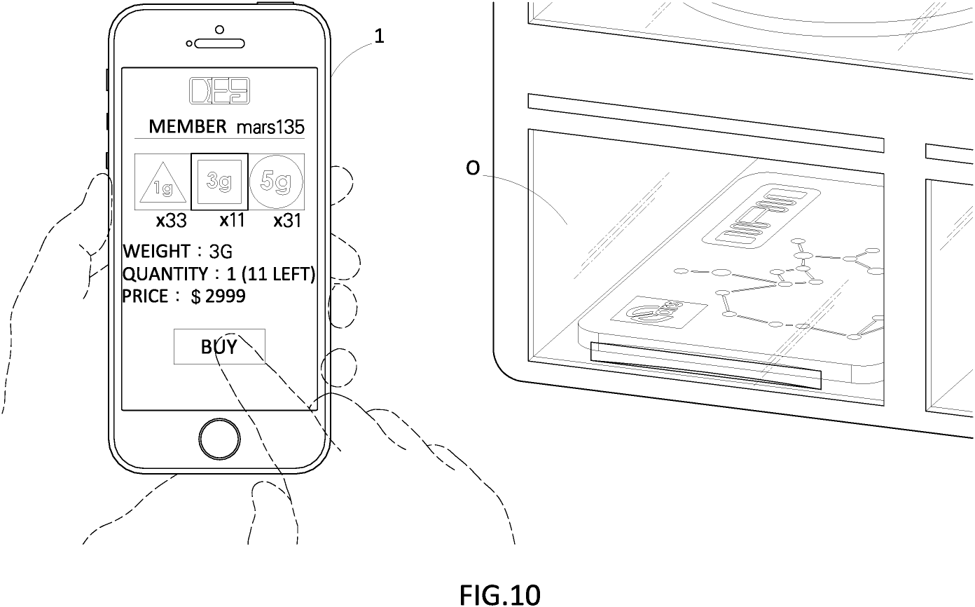

Step S11 of purchasing gold card (see FIG. 10): The sales module 26 drives the input/output device 5 to provide another gold stored in another container based on the product selection information received by the user interface module 21 and the payment information received by the cash flow module 24. In another embodiment, a certificate module 25 converts the pre-order information and the payment information received by the user interface module 21 into a certificate, and records the certificate in the user’s membership account or another user’s membership account. The sales module 26 drives the input/output device 5 to provide the gold contained in the container based on the aforementioned certificate.

Step S12 of returning: The computing module 23 drives the input/output device 5 to return the gold G based on the confirmation information.

As mentioned above, after logging into the membership account, the user can buy, sell, or pledge pre-register a gold card with identification information on the system or owned gold, gold jewellery, etc. through the interaction with the machine to obtain the corresponding payment in real time. Since each transaction and the gold sold by the machine will be recorded in the membership account, the trust of consumers in the gold transaction will be increased. Accordingly, a system, a device and a method for gold transaction of the present disclosure can ensure the fairness of the transaction and the authenticity of the gold without the need for a third party agency when the buyer and the seller trade gold online or offline.

### REFERENCE SIGN

| | |
|---|---|
| 1 | information device |
| 2 | data processing device |
| 21 | user interface module |
| 22 | membership module |
| 23 | computing module |
| 24 | cash flow module |
| 25 | certificate module |
| 26 | sales module |
| 3 | reading device |
| 4 | checking device |
| 5 | input/output device |
| 6 | image capturing device |
| 201 | machine |
| 202 | reader |
| 203 | payment unit |
| 204 | inspecting and sensing unit |
| 205 | video camera |
| 206 | display |
| S1 | checking whether a user is a member |
| S2 | checking whether an identification information is read |
| S3 | checking whether gold is sensed |
| S4 | calculating gold price is executed |
| S5 | checking whether the sale is carried out |
| S6 | checking whether the pledge process is carried out |
| S7 | executing remittance |
| S8 | generating certificate |
| S9 | packaging gold |
| S10 | recording in the container |
| S11 | purchasing gold card |
| S12 | returning |
| I | product inlet |
| O | product outlet |
| G | gold |
| N | certificate |
| T1, T2 | wireless communication element |
| C1, C2 | container |

What is claimed is:

1. A system for gold transaction provided for a user to conduct a gold transaction after connecting with an information device through a network, comprising:
a reading device configured to read an identification information stored in a wireless communication element on a container accommodating the gold; and
a data processing device in information connection with the reading device, including:
a user interface module for receiving a membership information transmitted by the information device;
a membership module in information connection with the user interface module for determining whether the user has a membership account according to the membership information;
a computing module in information connection with the user interface module and the membership module, wherein, when the user has the membership account, a price of the gold is calculated based on the identification information and a real-time price of gold, and wherein the price is transmitted to the information device through the user interface module to obtain a confirmation information; and
a cash flow module in information connection with the membership module and the computing module so as to import an amount corresponding to the price based on the confirmation information into the membership account.

2. The system as claimed in claim 1, wherein a certificate module is in information connection with the membership module and the computing module, and wherein, when the confirmation information is the confirmation of the pledged loan of the gold, the certificate module converts the confirmation information into a certificate, and wherein the certificate is recorded in the membership account, and wherein the certificate is recorded in the wireless communication element by the reading device.

3. The system as claimed in claim 1, wherein a checking device is in information connection with the data processing device, and wherein, when the gold is placed in the container, the gold is sensed for obtaining a sensing information, and wherein the price is calculated by the data processing device based on the sensing information and the real-time gold price.

4. The system as claimed in claim 3, wherein a certificate module is in information connection with the membership module and the computing module, and wherein an input/output device is in information connection with the data processing device, and wherein, when the confirmation information is the confirmation of the pledged loan of the gold, the input/output device packages the gold in another container with another wireless communication element, and wherein the certificate module converts the confirmation information into a certificate, and wherein the certificate is recorded in the membership account, and wherein the reading device records the certificate in the wireless communication element.

5. The system as claimed in claim 1, wherein a sales module is in information connection with the user interface module, the membership module, and the computing module, and wherein an input/output device is in information connection with the data processing device, and wherein, when the user does not have the membership account, the sales module drives the input/output device to provide another gold stored in another container based on a selection information received by the user interface module and a payment information received by the cash flow module.

6. The system as claimed in claim 5, wherein a certificate module is in information connection with the user interface module and the membership module so as to convert a pre-order information received by the user interface module and the payment information into a certificate, and wherein the certificate is recorded in the membership account or another membership account, and wherein the sales module drives the input/output device to provide the other gold stored in the other container.

7. The system as claimed in claim 1, wherein at least one image capturing device is connected with the data processing device to store at least one image of the gold or the user into the membership account.

8. A device for gold transaction in information connection with an information device held by a user through a network for conducting a gold transaction, comprising:
a machine having at least one product inlet and at least one product outlet;
a transceiver disposed inside the machine and connected to the information device;
a reader disposed inside the machine for reading an identification information stored in a wireless communication element placed on a container that is positioned in the product inlet and accommodates a gold; and
a control circuit disposed inside the machine and connected to the transceiver and the reader, the control circuit being configured to determine whether the user has a membership account according to a membership information received by the transceiver, wherein, when the user has the membership account, the control circuit calculates a price of the gold based on the identification information and a real-time price of gold, and transmits the price to the information device through the transceiver to obtain a confirmation information, and wherein, based on the confirmation information, an amount corresponding to the price is transferred to the membership account.

9. The device as claimed in claim 8, wherein, when the confirmation information is to confirm the pledged loan of the gold, the control circuit converts the confirmation information into a certificate and records the certificate in the membership account, and wherein the reader records the certificate in the wireless communication element.

10. The device as claimed in claim 8, wherein an inspecting and sensing unit is disposed inside the machine and connected to the control circuit, and wherein, when the gold is not contained in the container and placed at the product inlet, the gold is sensed to obtain a sensing information, and wherein the control circuit calculates the price of the gold based on the sensing information and the real-time gold price.

11. The device as claimed in claim 10, wherein an input/output unit is disposed inside the machine and connected to the control circuit, and wherein, when the confirmation information is to confirm the pledged loan of the gold, the gold is packaged in another container with another wireless communication element, and wherein the control circuit converts the confirmation information into a certificate and records the certificate in the membership account, and wherein the reader records the certificate in the other wireless communication element.

12. The device as claimed in claim 8, wherein a payment unit and an input/output unit are respectively disposed inside the machine and connected to the control circuit, and wherein, based on a selection information received by the transceiver and a payment information received by the payment unit, the control circuit drives the input/output unit to transport another gold contained in another container to the product outlet.

13. The device as claimed in claim 12, wherein the control circuit converts a pre-order information and the payment information received by the transceiver into a certificate and records the certificate in the membership account, and wherein, when the control circuit receives the certificate, the input/output unit is driven to accommodate another designated gold and transport it to the product outlet.

14. The device as claimed in claim 8, wherein at least one video camera is connected to the control circuit for storing at least one image of the gold or the user into the membership account.

15. A method for gold transaction for a user through a network to conduct a gold transaction, comprising:
receiving a membership information transmitted by an information device through a user interface module and determining through a membership module whether the user has a membership account according to the membership information;
determining by a reading device whether an identification information stored in a wireless communication element on a container for accommodating a gold is received if the user has the membership account;
calculating a purchase price or a pledged loan price of the gold by a computing module according to the identification information and a real-time price of gold and transmitting the purchase price or the pledged loan price through the user interface module to the information device to obtain a confirmation information if the reading device obtains the identification information; and
transferring an amount corresponding to the purchase price or the pledged loan price to the membership account through a cash flow module based on the confirmation information.

16. The method as claimed in claim 15, wherein, when the confirmation information is to confirm the pledged loan, a certificate module converts the confirmation information into a certificate and records the certificate in the membership account.

17. The method as claimed in claim 16, wherein the certificate is recorded on the wireless communication element on the container containing the gold by the reading device.

18. The method as claimed in claim 15, further comprising the step of checking the gold by the checking device and determining whether the gold is sensed to create a sensing information if the reading device cannot obtain the identification information and when the gold is not accommodated in the container, and wherein, if the checking device obtains the sensing information, the computing module calculates the purchase price or the pledged loan price according to the sensing information and the real-time price of gold, and wherein an input-output device is configured to package the gold in a container with another wireless communication element.

19. The method as claimed in claim 18, wherein, when the confirmation information is to confirm the pledged loan, a certificate module is configured to convert the confirmation information into a certificate and to record the certificate in the membership account.

20. The method as claimed in claim 19, wherein the certificate is recorded on the wireless communication element on the container containing the gold by the reading device.

21. The method as claimed in claim 18, wherein, if the user does not have the membership account or the checking device cannot obtain the sensing information, an input/output device is driven by a sales module to provide another gold contained in another container based on a selection information received by the user interface module and a payment information received by the cash flow module.

22. The method as claimed in claim 21, wherein a pre-order information and the payment information received by the user interface module are converted into a certificate by a certificate module, and the certificate is recorded in the membership account or another membership account, whereupon the sales module drives the input/output device to provide the other gold stored in the other container based on the certificate.

23. The method as claimed in claim 15, wherein at least one image capturing device is configured to store at least one image of the gold or the user into the membership account.
